(19) United States
(12) Patent Application Publication
(10) Pub. No.: US 2006/0112314 A1
(43) Pub. Date: May 25, 2006

(54) Computer health check method

(76) Inventor: Carlos Soto, Morgan Hill, CA (US)

Correspondence Address: KAPLAN GILMAN GIBSON & DERNIER L.L.P., 900 ROUTE 9 NORTH, WOODBRIDGE, NJ, 07095, US

(21) Appl. No.: 10/985,140

(22) Filed: Nov. 10, 2004

(51) Int. Cl. G06F 11/00

(52) U.S. Cl. 714/38

(57) ABSTRACT

A method for providing maintenance services to client computers is disclosed, in which a health check software application periodically runs in each client computer to obtain health information of each client computer and then automatically transmits the obtained health information to a remote service provider for monitoring and diagnosing the client computers.

### TECHNICAL FIELD

The present invention relates to computer maintenance techniques, and more particularly, to a method for health checking a client computer and reporting the health information to a remote service provider for diagnosis.

### BACKGROUND OF THE INVENTION

When a client computer encounters a problem, the client often contacts a maintenance service provider for help. To diagnose the client computer, the service provider usually runs a PC health check software application on the client computer to obtain health information of the client computer and to find errors in the client computer. If the service provider is remotely located from the client computer, the client may be instructed to run the health check software application to collect the health information and then provide the health information to the service provider. Based on the health information obtained, the service provider may determine the errors existing in the client computer and remedy the problems.

However, this may not be an efficient way to keep the client computer operating properly, because often it is too late when the client, who is usually not a computer professional, becomes aware of the errors and problems existing in the client computer. For example, the service provider often may not know that the version of the anti-virus software is not an updated one before the client reports that the client computer has been affected by virus.

Therefore, there exists a need for a solution to timely find errors existing in the client computers so as keep the client computers running in a healthy state and to prevent potential problems.

### SUMMARY OF THE INVENTION

The present invention provides a novel method in which a health check software application runs on a client computer to periodically obtain health information of the client computer, which is automatically transmitted to a service provider. Thus, the service provider is able to monitor the health situation of the client computer and to diagnose and solve the problems, if any, in a timely way. The health information preferably includes information about the operating system, the version of the anti-virus software, bug patches, the last check and backup time, etc., in the client computer.

Preferably, the service provider is remotely located from the client computer and communicates with the client computer over a data connection. Preferably, the health information is backed up at the service provider.

Preferably, the service provider also backs up configuration information of the client computer so that when the client computer needs to be replaced or restored, the backed up configuration information can be used to restore the configuration of the client computer or to configure a replacing client computer. Preferably, the backed up configuration information can be changed based on the diagnosis result of the client computer.

Preferably, the service provider automatically provides data backup services to the client computers as well.

### BRIEF DESCRIPTION OF THE DRAWINGS

FIG. 1 is a schematic illustration of the computer maintenance system of an embodiment according to the present invention; and

FIG. 2 is a flow chart showing the method according to an embodiment of the present invention.

### DETAILED DESCRIPTION OF THE PREFERRED EMBODIMENT

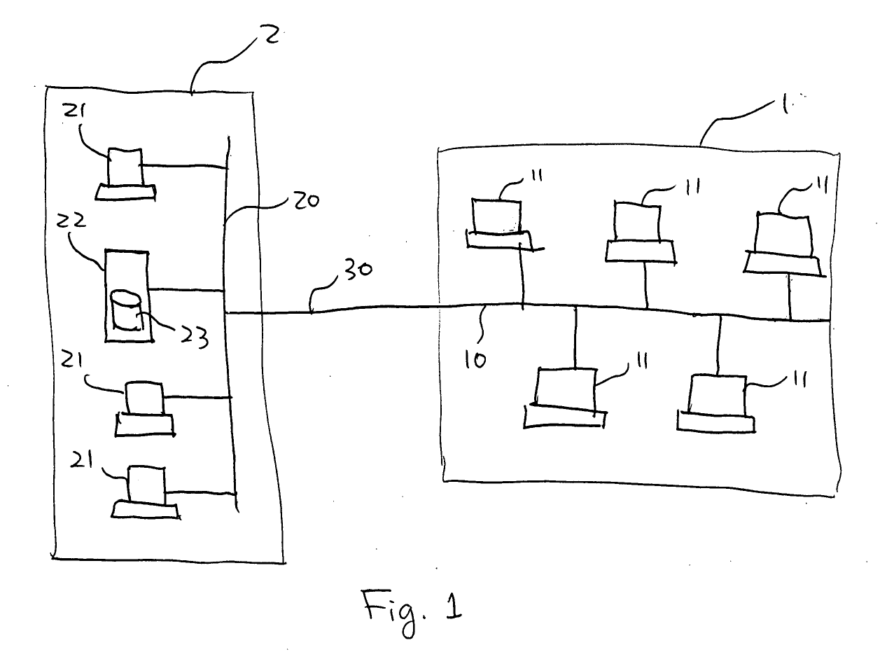

FIG. 1 illustrates an exemplary embodiment of the maintenance service provider system according to the teachings of the present invention. A service provider 2 provides maintenance services to a network 1 which comprises a plurality of client computers 11 connected to each other over a local area network (LAN) 10. The service provider 2 may include plural of agent terminals 21 and a server 22 connected over a local area network (LAN) 20. Preferably, the service provider 2 may be remotely located from network 1, and communicates with network 1 over a data connection 30 such as Internet.

According to the teachings of the present invention, a health check software application is installed in each client computer 11 and periodically runs to obtain health information of each client computer 11. The obtained health information is then automatically transmitted to the server 22 of the service provider 2 through the data connection 30. Thus, a service agent at the service provider 2 can monitor and diagnose the health situation of each client computer 11 from the periodically updated health information received from each particular computer 11. Any error or problem existing in the client computers 11 can be noticed and corrected by the agent at an early stage, without a need to wait for a trouble report from the users as in the prior art. Timely correcting the error at an early stage may avoid potential serious problems. Additionally, the client computers 11 can be health checked and the errors corrected without interaction from the users of the client computers 11, and the users may be even unaware that the diagnosis and correction of the errors are under way in the computers. Minimum involvement of the users may be advantageous in that it avoids mistakes and eliminates the need for a user to have computer expertise.

Preferably, the health information is backed up at storage 23 of the server 22, which can be retrieved by an agent at a terminal 21 to diagnose the client computers 11 at a later convenient time. In an embodiment, the server 22 may update the backed up health information each time it receives most current health information from the client computers 11.

The health information obtained by the health check software may comprise, but is not limited to, information about its operating system, versions of software, when said health information was obtained and/or backed up last time, spyware, bug patches, system resources, network connections, security, etc., of the client computers 11. For example, the health information may comprise information of the version of anti-virus software and when the virus definition was updated last time, information about the availability of the system resources such as CPU, memory, graphic card, sound card, storage disks, the drivers of them, disk fragmentation, etc. The health information may also include information about the historical configuration of the computers.

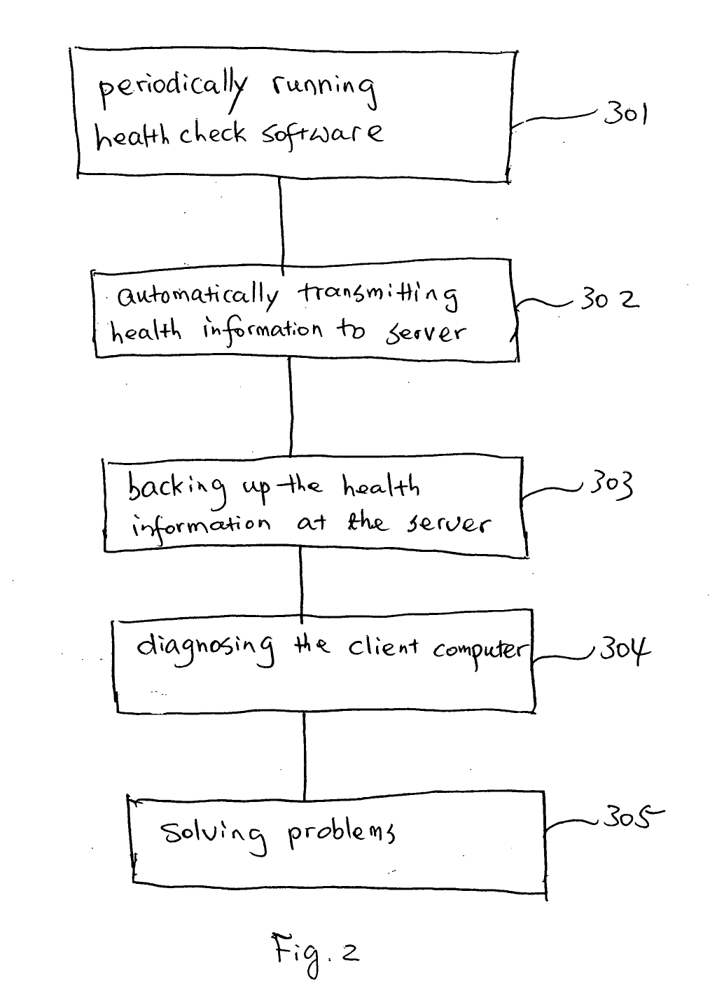

The operation of the system in FIG. 1 is illustrated in FIG. 2. The health check software application periodically runs in a client computer 11, at step 301, to obtain health information of the client computer 11. Then the obtained health information is automatically transmitted, at step 302, to the server 22 of the service provider 2, which saves the health information in the storage 23 of the server 22, at step 303. At step 304, an agent at an agent terminal 21 retrieves the health information of a client computer 11 from the storage 23 of the server 22 to diagnose the client computer 11 to determine the errors or problems, if any, existing in the client computer 11, and corrects the errors and solves the problems in the client computer 11, at step 305 if errors and/or problems are found.

In addition to providing maintenance services, the service provider 2 may also provide other services to the network 1 and client computers 11. In a preferred embodiment, the service provider 2 also provides service for backing up configuration information of the network 1 as well as the client computers 11. Thus, when one of the client computers 11 is replaced with a new computer or even the entire network 1 is replaced, the configuration information backed up at the service provider 2 can be used to configure the replacing new computer or the whole new network. The backed up configuration information may also be used to restore a client computer 11 if, for example, the client computer 11 is crashed.

Preferably, the configuration information backed up at the service provider 2 can be changed according to results obtained by analyzing the information received from the agent. For example, if a client computer 11 is found to have a security problem in its network connection, the maintenance service agent may need to change the network connection configuration at the client computer 11 so as to solve the problem. After that, the configuration information of the client computer 11 backed up at the service provider 2 is preferably also changed accordingly.

The above has described preferred embodiments of the present invention. However, it shall be appreciated that many variations, adaptations and modifications are possible to a person with ordinary skill in the art without departing from the spirit of the present invention. For example, the service provider 2 may be an administrator within the network 1 which communicates with the client computers over LAN 10. Therefore, the scope of the present invention is solely intended to be defined in the accompanying drawings.

What is claimed is:

1. A method for maintaining a client computer, comprising:
periodically running a health check software application on the client computer to obtain health information of said client computer; and
automatically transmitting said health information to a service provider for diagnosing said client computer.

2. The method of claim 1, further comprising monitoring, at said service provider, health situation of said client computer based on said health information.

3. The method of claim 1, wherein said service provider is remotely located from said client computer and communicates with said client computer over a data connection.

4. The method of claim 3, wherein said health information is transmitted to said service provider over said data connection.

5. The method of claim 1, further comprising backing up said health information at said service provider.

6. The method of claim 5, further comprising updating said backed up health information at said service provider upon receiving most recent health information from said client computer.

7. The method of claim 4, wherein said service provider also provides service of backing up configuration information of said client computer.

8. The method of claim 7, further comprising changing said backed up configuration information based on result of said diagnosing.

9. The method of claim 1, wherein said health information comprises information about at least one of following: operating system, versions of software, when said health information was obtained last time, spyware, bug patches, system resources, network connections, security, and registry of said client computer.

10. The method of claim 9, wherein health information comprises information about version of anti-virus software.

11. The method of claim 10, wherein said health information further comprises when a definition of virus was last updated for said anti-virus software.

12. The method of claim 9, wherein said system resources comprises at least one of following: motherboards, CPU, memory, graphic card, sound card, storage disks.

13. The method of claim 12, wherein said information comprises information about availability of said system resources.

14. The method of claim 12, wherein said information comprises information about drivers of said system resources.

15. A system for maintaining a plurality of client computers, comprising:
a server for providing maintenance services to said client computers; and
a health check software application configured to periodically run on each of said client computers to obtain health information of said each client computer and to automatically transmit said obtained health information to said server.

16. The system of claim 15, wherein said services comprising diagnosing said client computers based on said obtained health information.

17. The system of claim 16, wherein said server is remotely located from said client computers and communicates with said client computers over a data connection.

18. The system of claim 17, wherein said server comprises means for backing up said obtained health information.

19. The system of claim 18, wherein said server further comprises means for backing up configuration information of said client computers.

20. The system of claim 19, wherein said server further comprises means for altering said backed up configuration information based on a result of said diagnosing.

21. The system of claim 15, wherein said health information comprises information about at least one of following: operating system, versions of software, when said health information was obtained last time, spyware, bug patches, system resources, network connections, security, and registry of said client computer.

22. The system of claim 21, wherein said health information further comprises information about version of anti-virus software and when a definition of virus was last updated for said anti-virus software.
